(19) United States
(12) Patent Application Publication
(10) Pub. No.: US 2013/0254674 A1
(43) Pub. Date: Sep. 26, 2013

(54) DEVELOPMENT MODE ACTIVATION FOR A MOBILE DEVICE

(71) Applicant: Gregory PEKOFSKY, Dollard-des-Ormeaux (CA)

(72) Inventor: Gregory PEKOFSKY, Dollard-des-Ormeaux (CA)

(73) Assignee: Oracle International Corporation, Redwood Shores, CA (US)

(21) Appl. No.: 13/428,106

(22) Filed: Mar. 23, 2012

(51) Int. Cl. G06F 3/01

(52) U.S. Cl. 715/744

(57) ABSTRACT

A development mode system that activates a development mode of a software application that is executed on a mobile device is provided. The development mode system detects an acceleration of the mobile device. The development mode system further determines that the acceleration exceeds a threshold. The development mode system further displays a user interface within the mobile device in response to determining that the acceleration exceeds the threshold, where the user interface activates the development mode in response to a user interaction with the user interface, and where the development mode provides access to one or more features of the software application that are not available during conventional execution of the software application. The development mode system further receives the user interaction within the user interface. The development mode system further activates the development mode in response to the user interaction with the user interface.

### FIELD

One embodiment is directed to a mobile device, and more particularly, to a software application executed on a mobile device.

### BACKGROUND

Software applications that are executed on a mobile device sometimes require access to hidden features, such as a “development mode.” A development mode provides advanced features in a software application, which can generally assist software developers and information technology support staff in solving problems with the software application, such as troubleshooting errors in the execution of the software application. Since these advanced features are usually not very helpful to an end user for conventional usage of the software application (and can, in fact, interfere with conventional usage, due to the user's lack of sophisticated knowledge regarding the mobile application), such hidden features should be relatively hard for users to access, so as to prevent inadvertent access. To this end, the user is generally not informed about these hidden features, until the user is experiencing problems with the software application, and such hidden features are required to be disclosed to the user in order to facilitate troubleshooting of the software application, usually under supervision or direct involvement by a software developer or information technology support staff.

### SUMMARY

One embodiment is directed to a development mode system that activates a development mode of a software application that is executed on a mobile device. The development mode system detects an acceleration of the mobile device. The development mode system further determines that the acceleration exceeds a threshold. The development mode system further displays a user interface within the mobile device in response to determining that the acceleration exceeds the threshold, where the user interface activates the development mode in response to a user interaction with the user interface, and where the development mode provides access to one or more features of the software application that are not available during conventional execution of the software application. The development mode system further receives the user interaction within the user interface. The development mode system further activates the development mode in response to the user interaction with the user interface.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a mobile device that may implement an embodiment of the present invention.

FIG. 2 illustrates a diagram of a user interface displayed by a mobile device, according to an embodiment of the invention.

FIG. 3 illustrates a flow diagram of the functionality of a development mode module, according to an embodiment of the invention.

FIG. 4 illustrates another flow diagram of the functionality of a development mode module, according to an embodiment of the invention.

### DETAILED DESCRIPTION

One embodiment is directed to a development mode system that allows a user to access a development mode of a software application that executes on a mobile device. The development mode system first detects a movement of the mobile device, such as a shaking of the mobile device. This detection can be achieved by detecting an acceleration of an accelerometer contained within the mobile device. In order to distinguish between types of movements of the mobile device, so that only certain movements of the mobile device activate the development mode of the software application, the development mode system can detect a plurality of delta accelerations between time intervals, and sum together the plurality of delta accelerations. When this sum exceeds a threshold, the development mode system can determine that the movement of the mobile device is a movement that should activate the development mode of the software application. When a duration of this movement has exceeded a threshold, the development mode system can display a user interface within the mobile device. When a user performs an action within the user interface, the development mode system can access a development mode of the software application that executes on the mobile device, where the development mode provides access to one or more features of the software application that are not available during conventional execution of the software application. For example, when a user shakes the mobile device for a duration of ten seconds, the development system can determine that the shaking of the mobile device for the duration of ten seconds should activate the development mode of the software application, and display the user interface within the mobile device in response to the shaking of the mobile device.

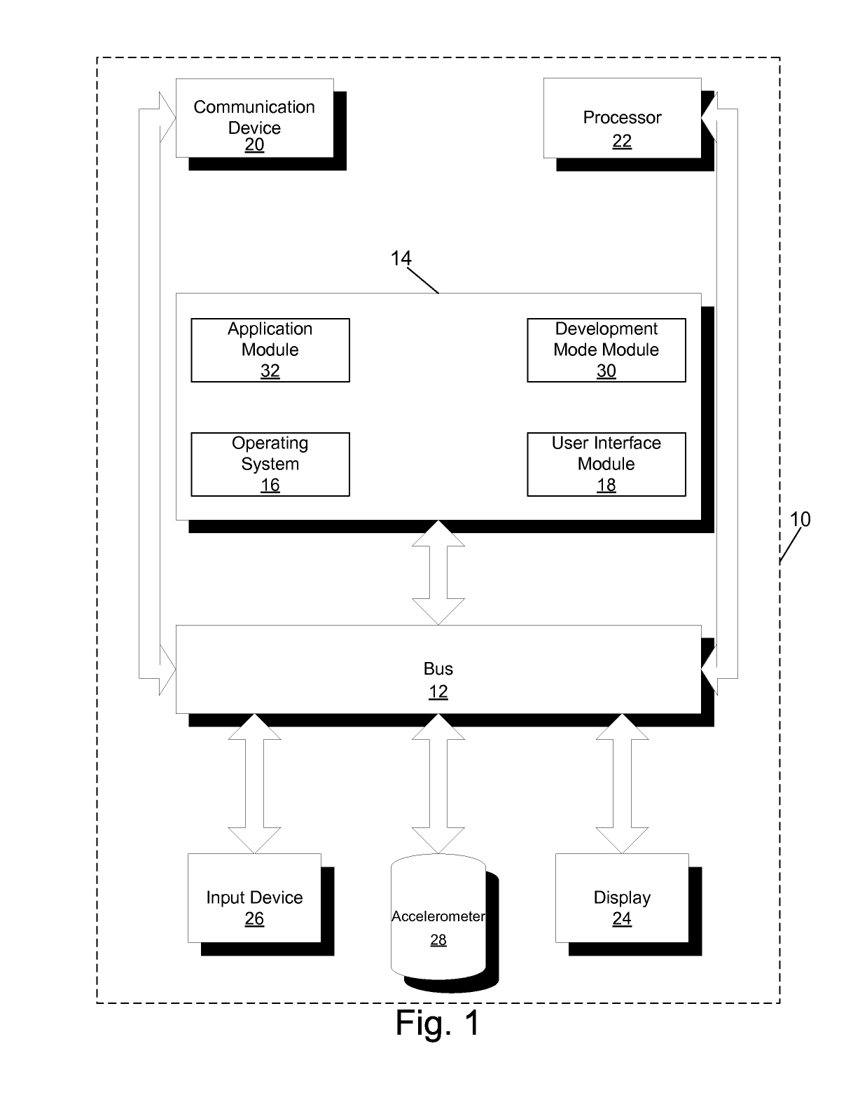

FIG. 1 illustrates a block diagram of a mobile device 10 that may implement one embodiment of the invention. As appreciated by one of ordinary skill in the relevant art, a mobile device is a compact device. According to the embodiment, mobile device 10 can be a mobile computer, a mobile phone, a smartphone (such as an Apple iPhone® device, a Research In Motion Blackberry® device, a Samsung Galaxy Nexus® device, and a smartphone executing a Google Android® operating system), a tablet computer (such as an Apple iPad® device, a Research in Motion Blackberry Playbook® device, a Samsung Galaxy® device, and a tablet computer executing a Google Android® operating system), a personal digital assistant (“PDA”), a calculator, a handheld game console, a portable media player, a digital still camera, a digital video camera, a pager, a personal navigation device, or another similar type of mobile device. Mobile device 10 includes a bus 12 or other communications mechanism for communicating information between components of mobile device 10. Mobile device 10 also includes a processor 22, operatively coupled to bus 12, for processing information and executing instructions or operations. Processor 22 may be any type of general or specific purpose processor. Mobile device 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. Mobile device 10 further includes a communication device 20, such as a transceiver or other communications interface, to provide access to a network. As a result, a user may interface with mobile device 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. An input device 26, such as a key pad, keyboard, and touch screen, can also be operatively coupled to bus 12 to enable the user to interface with mobile device 10. Processor 22 can also be operative coupled via bus 12 to an accelerometer 28. Accelerometer 28 is a device that can measure proper acceleration, where proper acceleration is a physical acceleration experienced by mobile device 10. For example, when a user causes mobile device 10 to move according to a specific movement (such as when a user shakes mobile device 10), accelerometer 28 can measure the acceleration experienced by mobile device 10 that is caused by the specific movement.

According to one embodiment, memory 14 can store software modules that can provide functionality when executed by processor 22. The modules can include an operating system 16 and a user interface module 18. Operating system 16 can provide an operating system functionality for mobile device 10. User interface module 18 can provide functionality allowing a user to interact with mobile device 10.

The modules stored on memory 14 can also include a development mode module 30 and an application module 32. Development mode module 30 can provide functionality for displaying a user interface that allows a user to access a development mode of application module 32, as will be described in more detail below. In certain embodiments, development mode module 30 can comprise a plurality of modules that each provide specific individual functionality for displaying a user interface that allows a user to access a development mode of application module 32. Application module 32 is a software application (also identified as a “mobile application” or an “application”) that can be executed by processor 22, via bus 12, and provide specific functionality to mobile device 10. For example, application module 32 can be an application that provides global positioning system (“GPS”) navigation functionality. As another example, application module 32 can be an application that provides gaming functionality. Each of the modules stored in memory 14 can interface with each other, as well as with other components of mobile device 10. While in the illustrated embodiment of FIG. 1, mobile device 10 includes a single application module, one of ordinary skill in the art would appreciate that this is an example embodiment, and that mobile device 10 can include any number of application modules.

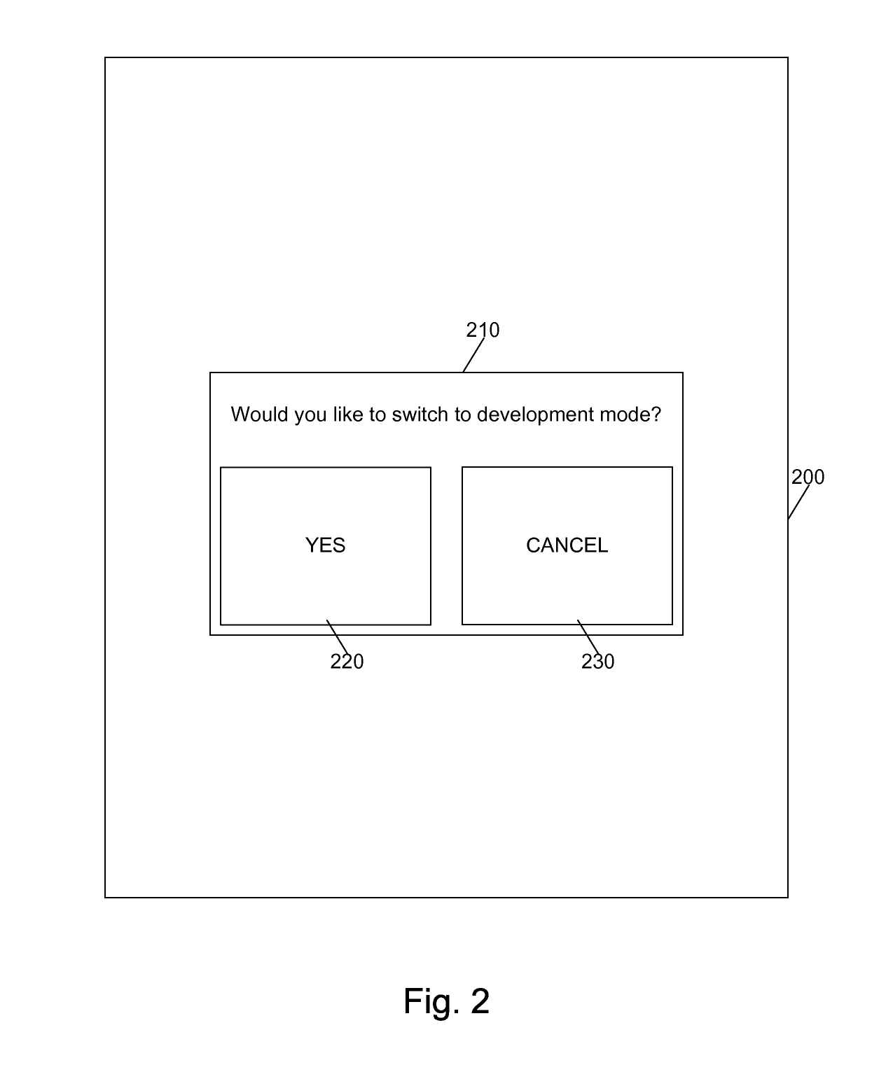

FIG. 2 illustrates a diagram of a user interface 210 displayed by a mobile device 200, according to an embodiment of the invention. According to the embodiment, when an accelerometer (not shown in FIG. 2) of mobile device 200 detects a movement of mobile device 200, and the movement is determined to be a movement that activates a development mode of a software application that executes on mobile device 200, mobile device 200 displays user interface 210. As illustrated in FIG. 2, user interface 210 can display a message to a user, such as “Would you like to switch to development mode?” As also illustrated in FIG. 2, user interface 210 can display two buttons, buttons 220 and 230, that a user can interact with, such as touching a screen where user interface 210 is displayed, or touching a button on mobile device 200. In the illustrated embodiment, button 220 displays the text “YES,” and button 230 displays the text “CANCEL.” Upon a user interaction with button 220 of user interface 210, a development mode of the software application that executes on mobile device 200 is activated. Such a user interaction with button 220 can include a selection of button 220, where the selection can be accomplished via a touchscreen, or other input device, of mobile device 200. Upon a user interaction with button 230 of user interface 210, user interface 210 is no longer displayed within mobile device 200. Such a user interaction with button 230 can include a selection of button 230, where the selection can be accomplished via a touchscreen, or other input device, of mobile device 200.

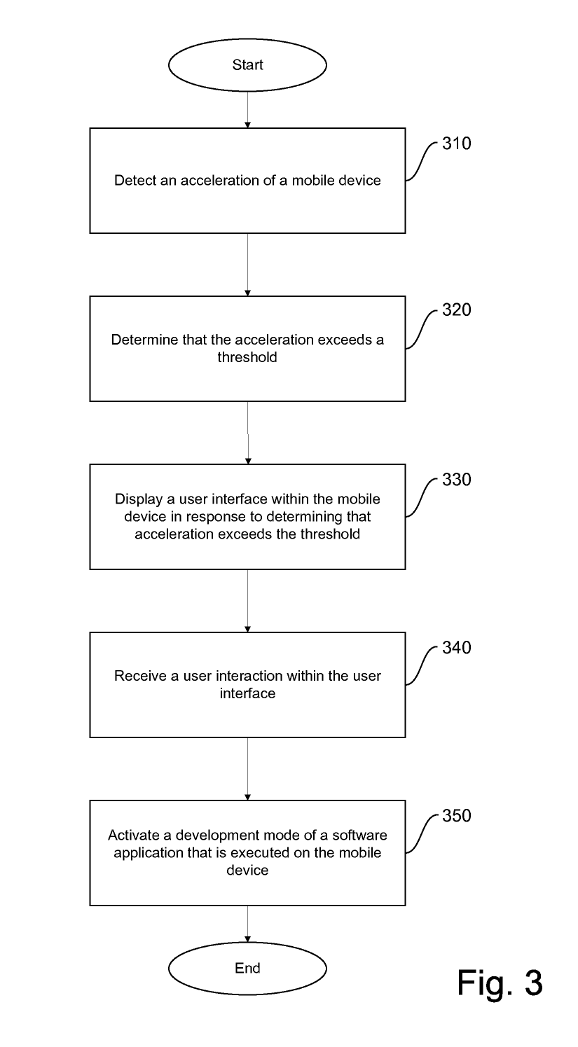

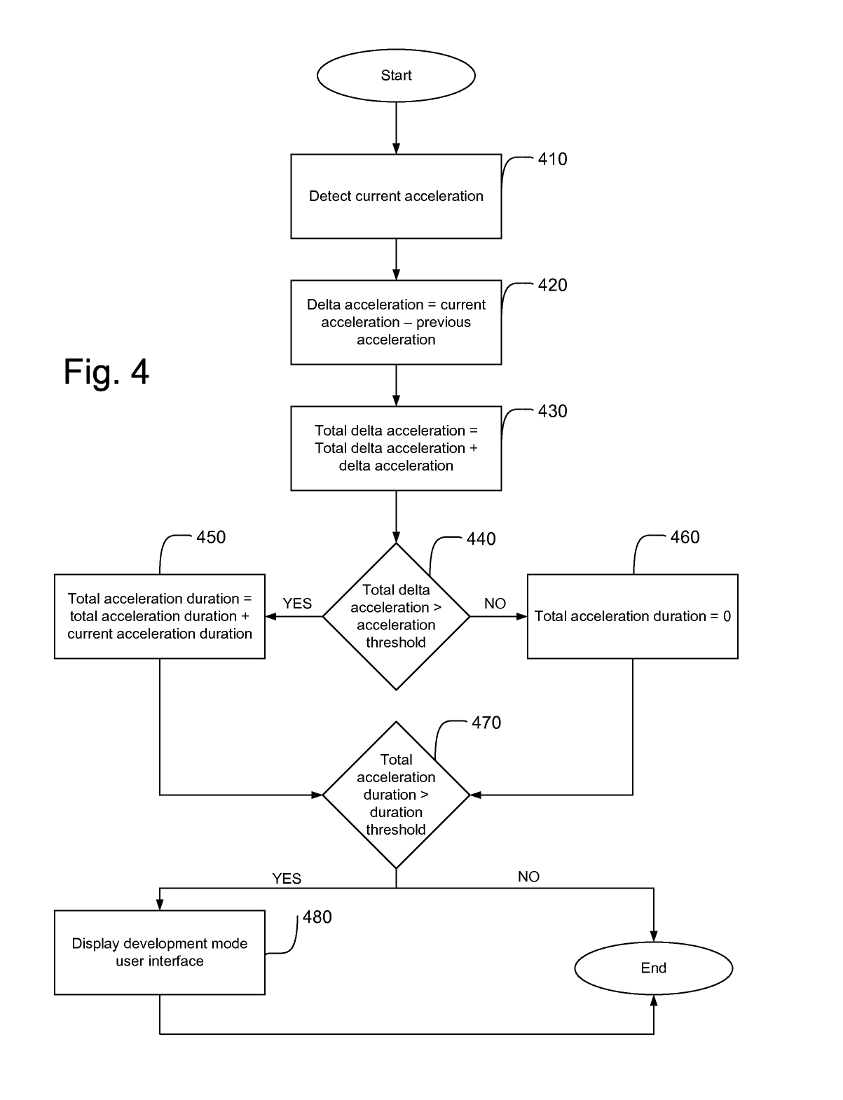

FIG. 3 illustrates a flow diagram of the functionality of a development mode module, according to an embodiment of the invention. In certain embodiments of the invention, the development mode module is similar to development mode module 30 of FIG. 1. In one embodiment, the functionality of the flow diagram of FIG. 3, and the functionality of the flow diagram of FIG. 4, is implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software.

The flow begins and proceeds to 310. At 310, an acceleration of a mobile device is detected. In some embodiments, the mobile device is a smartphone. In other embodiments, the mobile device is a tablet. In certain embodiments, the acceleration of the mobile device is caused by shaking the mobile device. In certain embodiments, the acceleration of the mobile device is detected by an accelerometer contained within the mobile device. The flow then proceeds to 320. At 320, it is determined that the acceleration exceeds a threshold. A threshold can be a specified value used to distinguish between distinguish between types of movements of the mobile device, such as incidental movement of the mobile device and intentional movement of the mobile device. A threshold can be an acceleration threshold or a duration threshold, as described below in greater detail with respect to FIG. 4. The flow then proceeds to 330.

At 330, a user interface is displayed within the mobile device in response to the determination that the acceleration exceeds the threshold. The user interface can activate a development mode of a software application that is executed on the mobile device in response to a user interaction with the user interface. The development mode can provide access to one or more features of the software application that are not available during conventional execution of the software application. In certain embodiments, at least one of the features is used to troubleshoot the software application. The flow then proceeds to 340. At 340, a user interaction is received within the user interface. In certain embodiments, the user interaction can be a selection of a button displayed within the user interface, where the selection can be accomplished via a touchscreen, or other input device, of the mobile device. The flow then proceeds to 350. At 350, the development of the software application is activated. In certain embodiments, if another user interaction is received within the user interface, the user interface is not longer displayed within the mobile device. The flow then ends.

FIG. 4 illustrates another flow diagram of the functionality of a development mode module, according to an embodiment of the invention. In certain embodiments of the invention, the development mode module is similar to development mode module 30 of FIG. 1. The flow begins and proceeds to 410. At 410, an acceleration of a mobile device (identified as a “current acceleration”) over a duration (i.e., “current duration”) is detected. This current acceleration can be caused by any type of movement of the mobile device, such as shaking the mobile device. In certain embodiments, the current acceleration is detected by an accelerometer contained within the mobile device. According to these embodiments, an application programming interface (“API”) is configured to receive a detected acceleration value from the accelerometer. The flow then proceeds to 420.

At 420, a delta acceleration is calculated by calculating a difference of the current acceleration over the current duration and a previous acceleration of the mobile device over a previous duration. According to the embodiment, a previous acceleration of the mobile device over a previous duration is recorded. The current acceleration is compared with the previous acceleration to determine a change in acceleration from the previous duration and the current duration. The flow then proceeds to 430.

At 430, the delta acceleration is added to a total delta acceleration. The total acceleration can represent a sum of a plurality of delta accelerations. In these embodiments, 410, 420, and 430 can be repeated each for the plurality of delta accelerations to calculate the total delta acceleration. The flow then proceeds to 440.

At 440, it is determined whether the total delta acceleration exceeds an acceleration threshold. An acceleration threshold can be a specified acceleration value that can be utilized to distinguish between types of movements of the mobile device, such as incidental movement of the mobile device and intentional movement of the mobile device, based on the acceleration generated by such movements. According to the embodiment, if the total delta acceleration exceeds the acceleration threshold, the flow proceeds to 450. If the total delta acceleration does not exceed the acceleration threshold, the flow proceeds to 460. Thus, according to the embodiment a determination is made whether a specific amount of acceleration has occurred.

At 450, a duration of the acceleration of the mobile device (identified as “current acceleration duration”) is added to a total acceleration duration. The total acceleration duration can represent a total duration of a plurality of consecutive accelerations of the mobile device (i.e., a sum of the durations of the plurality of consecutive accelerations), where a corresponding total delta acceleration (i.e., a corresponding sum of the delta accelerations of the plurality of consecutive accelerations) exceeds the acceleration threshold. In these embodiments, 450 can be repeated for each of the plurality of acceleration durations to calculate the total acceleration duration. Thus, according to the embodiment, the current delta acceleration adjusts the total delta acceleration such that the total delta acceleration exceeds the acceleration threshold, and thus, the current acceleration duration is added to the total acceleration duration. The flow then proceeds to 470.

At 460, the total acceleration duration is set to a value of 0. Thus, according to an embodiment, the current delta acceleration adjusts the total delta acceleration such that the total delta acceleration does not the acceleration threshold, and thus, the total acceleration duration is reset. The flow then proceeds to 470.

At 470, it is determined whether the total acceleration duration exceeds a duration threshold. A duration threshold can be a specified duration value that can be utilized to distinguish between types of movements of the mobile device, such as incidental movement of the mobile device and intentional movement of the mobile device, based on the duration of such movements. According to the embodiment, if the total acceleration duration exceeds the duration threshold, the flow proceeds to 480. If the total acceleration duration does not exceed the duration threshold, the flow ends. Thus, according to the embodiment a determination is made whether a specific amount of acceleration is occurring over a specific duration.

At 480, a development mode user interface is displayed at the mobile device. The user interface can activate a development mode of a software application that is executed on the mobile device in response to a user interaction with the user interface. The development mode can provide access to one or more features of the software application that are not available during conventional execution of the software application. The flow then ends.

Thus, according to an embodiment of the invention, a development mode system can be provided, that can require a user to shake a mobile device with a specified acceleration for a specified duration to cause a user interface to be displayed within the mobile device, where the user interface allows a user to access a development mode of a software application that is executed within the mobile device. For example, shaking the mobile device for ten second can produce the specified acceleration for the specified duration, and cause the development mode system to display the user interface within the mobile device. This allows for users to be able to access one or more features of the software application that are not available during conventional execution of the software application, and are only available within a development mode of the software application. This also makes it more difficult to accidentally or unintentionally activate the development mode of the software application.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to activate a development mode of a software application that is executed on a mobile device, the instructions comprising:
detecting an acceleration of the mobile device;
determining that the acceleration exceeds a threshold;
displaying a user interface within the mobile device in response to determining that the acceleration exceeds the threshold, wherein the user interface activates the development mode in response to a user interaction with the user interface, and wherein the development mode provides access to one or more features of the software application that are not available during conventional execution of the software application;
receiving the user interaction within the user interface; and
activating the development mode in response to the user interaction with the user interface.

2. The computer-readable medium of claim 1, wherein the detecting the acceleration of the mobile device further comprises:
detecting the acceleration of the mobile device over a duration;
calculating a delta acceleration by calculating a difference of the acceleration of the mobile device over the duration and a previous acceleration of the mobile device over a previous duration;
repeating the detecting the acceleration and the calculating the delta acceleration for a plurality of accelerations, wherein a plurality of delta accelerations is created; and
calculating a total delta acceleration by summing the plurality of delta accelerations.

3. The computer-readable medium of claim 2, wherein the determining that the acceleration exceeds the threshold further comprises:
determining that the total delta acceleration exceeds an acceleration threshold; and
determining that a duration of a total acceleration exceeds a duration threshold.

4. The computer-readable medium of claim 3, wherein the duration of the total acceleration is calculated by:
calculating a duration of each acceleration of the plurality of accelerations; and
summing the plurality of durations.

5. The computer-readable medium of claim 1, wherein the acceleration of the mobile device is caused by shaking the mobile device.

6. The computer-readable medium of claim 1, wherein at least one of the features is used to troubleshoot the software application.

7. The computer-readable medium of claim 1, the instructions further comprising:
receiving another user interaction within the user interface; and
causing the user interface not to be displayed within the mobile device.

8. The computer-readable medium of claim 1, wherein the acceleration of the mobile device is detected by an accelerometer contained within the mobile device.

9. The computer-readable medium of claim 1, wherein the mobile device comprises a smartphone.

10. The computer-readable medium of claim 1, wherein the mobile device comprises a tablet.

11. A computer-implemented method for activating a development mode of a software application that is executed on a mobile device, the method comprising:
detecting an acceleration of the mobile device;
determining that the acceleration exceeds a threshold;
displaying a user interface within the mobile device in response to determining that the acceleration exceeds the threshold, wherein the user interface activates the development mode in response to a user interaction with the user interface, and wherein the development mode provides access to one or more features of the software application that are not available during conventional execution of the software application;
receiving the user interaction within the user interface; and
activating the development mode in response to the user interaction with the user interface.

12. The computer-implemented method of claim 11, wherein the detecting the acceleration of the mobile device further comprises:
detecting the acceleration of the mobile device over a duration;
calculating a delta acceleration by calculating a difference of the acceleration of the mobile device over the duration and a previous acceleration of the mobile device over a previous duration;
repeating the detecting the acceleration and the calculating the delta acceleration for a plurality of accelerations, wherein a plurality of delta accelerations is created; and
calculating a total delta acceleration by summing the plurality of delta accelerations.

13. The computer-implemented method of claim 12, wherein the determining that the acceleration exceeds the threshold further comprises:
determining that the total delta acceleration exceeds an acceleration threshold; and
determining that a duration of a total acceleration exceeds a duration threshold.

14. The computer-implemented method of claim 13, wherein the duration of the total acceleration is calculated by:
calculating a duration of each acceleration of the plurality of accelerations; and
summing the plurality of durations.

15. The computer-implemented method of claim 11, wherein the acceleration of the mobile device is caused by shaking the mobile device.

16. A development mode system for a mobile device, the development mode system comprising:
a memory configured to store a development mode module;
a processor configured to execute the development mode module stored on the memory; and
an accelerometer configured to detect the acceleration of the mobile device over a duration;
wherein, when executing the development mode module, the processor is further configured to determine that the acceleration exceeds a threshold;
wherein, when executing the development mode module, the processor is further configured to display a user interface within the mobile device in response to determining that the acceleration exceeds the threshold, wherein the user interface activates the development mode in response to a user interaction with the user interface, and wherein the development mode provides access to one or more features of the software application that are not available during conventional execution of the software application;
wherein, when executing the development mode module, the processor is further configured to receive the user interaction within the user interface; and
wherein, when executing the development mode module, the processor is further configured to activate the development mode in response to the user interaction with the user interface.

17. The development mode system of claim 16, wherein the accelerometer is further configured to detect the acceleration of the mobile device over a duration;
wherein, when executing the development mode module, the processor is further configured to calculate a delta acceleration by calculating a difference of the acceleration of the mobile device over the duration and a previous acceleration of the mobile device over a previous duration;
wherein the accelerometer is further configured to repeat the detecting the acceleration and, when executing the development mode module, the processor is further configured to repeat the calculating the delta acceleration for a plurality of accelerations, wherein a plurality of delta accelerations is created; and
wherein, when executing the development mode module, the processor is further configured to calculate a total delta acceleration by summing the plurality of delta accelerations.

18. The development mode system of claim 17, wherein, when executing the development mode module, the processor is further configured to determine that the total delta acceleration exceeds an acceleration threshold; and
wherein, when executing the development mode module, the processor is further configured to determine that a duration of a total acceleration exceeds a duration threshold.

19. The development mode system of claim 18, wherein, when executing the development mode module, the processor is further configured to calculate a duration of each acceleration of the plurality of accelerations; and
wherein, when executing the development mode module, the processor is further configured to sum the plurality of durations.

20. The development mode system of claim 16, wherein the acceleration of the mobile device is caused by shaking the mobile device.
